(19) United States
(12) Patent Application Publication
(10) Pub. No.: US 2022/0274270 A1
(43) Pub. Date: Sep. 1, 2022

(54) Box Corner Cutting Device

(71) Applicant: Michael Leland MacPherson, Rancho Cucamonga, CA (US)

(72) Inventor: Michael Leland MacPherson, Rancho Cucamonga, CA (US)

(21) Appl. No.: 17/593,056

(22) PCT Filed: Jan. 8, 2020
(86) PCT No.: PCT/US20/12803

§ 371 Date: Sep. 8, 2021

(51) Int. Cl. B26B 5/00

(52) U.S. Cl. CPC B26B 5/003; B26B 5/005

(57) ABSTRACT

As shown in the figures, the device of the present invention is a hand held and hand operated cutting blade connectively attached to the bottom end of a pole that is housed in and partially contained within a capped cylindrical tube wherein there are tracks installed to guide the cutting blade up and down within the tube, and there are two openings (slots or channels) on the sidewall of the cylindrical tube which are used to be fitted over the sides of a box at the corner. As the tube is lowered to the bottom of the box, the blade will slide up into the tube and come to a rest positioned at the top of the corner of the box. The pole with blade can then be easily pushed down through the corner of the box cutting it from top to bottom.

### TECHNICAL FIELD OF THE INVENTION

This invention relates in general to hand held cutters such as cardboard and corrugated paper cutters and more particularly to safety cardboard and corrugated paper box cutters.

### BACKGROUND

Today's box cutters consist of manual cutters and machine based box cutting models.

There are manual safety box cutters as the following patents. U.S. Pat. No. 2,730,800 for a Safety Paper Box Cutter to Bailey on Jan. 17, 1956 wherein a simple cutting blade is covered with a protective sleeve when the device is not pressed against a working surface for cutting. U.S. Pat. No. 4,503,612 for a Safety Guard Equipped Cardboard Box Cutter to Davis on Mar. 12, 1985 wherein a simple cutting blade is shielded with a protective guard next to the blade and a metal spring blade guard that moves out of the way when cutting. U.S. Pat. No. 6,637,112 B2 for Box Cutter With Deflectable Safety Shield to Davis on Oct. 28, 2003 wherein a simple cutting blade is covered with a safety shield that falls into place when the blade is not is use.

There are machine based box cutters as in the following patents. U.S. Pat. No. 5,101,703 for Box Cutting Method and Apparatus Thereof to Tanaka, et al. on Apr. 7, 1992 wherein a powered cutting machine on an adjustable table is used to cut boxes. Patent Cooperation Treaty Application PCT/US90/05620 for Box Cutting Machine by Blodgett on Oct. 3, 1990 wherein a machine that moves a powered cutter across a box is used for cutting.

There are not presently any available hand held or machine based safety box cutters specifically for cutting the corners of the boxes with a portable hand held safety box cutting tool.

### BRIEF SUMMARY OF THE INVENTION

I have now invented a Box Corner Cutting Device. The device of the present invention is a new hand held portable safety tool for cutting the corners of boxes.

The device of the present invention is a hand held and hand operated cutting blade connectively attached to the bottom end of a pole that is housed in and partially contained within a capped cylindrical tube wherein there are tracks installed to guide the cutting blade up and down within the tube. There are two openings (slots or channels) on the sidewall of the cylindrical tube which are used to be fitted over the sides of a box at the corner. As the tube is lowered to the bottom of the box the blade will slide up into the tube and come to a rest positioned at the top of the corner of the box. The pole with blade can then be easily pushed down through the corner of the box cutting it from top to bottom.

### BRIEF DESCRIPTION OF THE DRAWINGS

The invention may be better understood by reference to the accompanying drawings, wherein:

FIG. 1 shows the complete Box Corner Cutting Device in three dimensional view with a half-section cut away to highlight the inter and intra-connective relationships between the elements that comprise the invention. As shown in this figure, element 100 is an embodiment of the complete device of the present invention. Element 20 is a pole. Element 90 is a cylindrical tube. Element 10 is a grip which is positioned on the top, upper, or handhold end on said pole (20). Element 80 a cutting blade that is connectively attached to the bottom, lower, or cutting end on said pole (20). Element 30 is a cap that safely contains the pole (20) with attached cutting blade (80) within the cylindrical tube (90). Element 40 is a collar that is attached to the pole if needed in a given embodiment to prevent the pole from advancing past the end of the tube. Element 50 is a recoil spring that is connectively attached to the cap (30) and/or pole (20) to slow and arrest downward or cutting direction motion of the pole (20) with attached cutting blade (80). Elements 60 are guide tracks or channels which guide the path of the cutting blade (80) from the top of the tube (90) to the bottom. Element 70 is a set of openings (slots or channels) on the sidewall of the cylindrical tube which set is used to be fitted over the sides of a box at the corner.

FIG. 2 shows a view the device of the present invention in three dimensional half-section cut-away view to highlight the inner components of the device from the inside looking towards the front of the device. As shown in this figure, element 10 is a grip, element 20 is a pole, element 30 is a cap, element 40 is a collar, element 50 is a recoil spring, elements 60 are the guide tracks, element 70 is a set of openings, element 80 is a cutting blade, element 90 is a cylindrical tube, and element 200 is the entire device.

FIG. 3 shows a view the device of the present invention in three dimensional half-section cut-away view to highlight the inner components of the device from the inside looking towards the back of the device. As shown in this figure, element 10 is a grip, element 20 is a pole, element 30 is a cap, element 40 is a collar, element 50 is a recoil spring, elements 60 are the guide tracks, element 80 is a cutting blade, element 90 is a cylindrical tube, and element 300 is the entire device.

FIG. 4 shows an optional octagonal shaped tube (90) embodiment of the present invention. As shown in this figure, element 400 is an embodiment of the complete device of the present invention. Element 20 is a pole. Element 90 is a cylindrical tube. Element 10 is a grip which is positioned on the top, upper, or handhold end on said pole (20). Element 80 a cutting blade that is connectively attached to the bottom, lower, or cutting end on said pole (20). Element 30 is a cap that safely contains the pole (20) with attached cutting blade (80) within the cylindrical tube (90). Element 40 is a collar that is attached to the pole if needed in a given embodiment to prevent the pole with blade from advancing past the end of the tube. Element 50 is a recoil spring that is connectively attached to the cap (30) and/or pole (20) to slow and arrest downward or cutting direction motion of the pole (20) with attached cutting blade (80). Elements 60 are guide tracks or channels which guide the path of the cutting blade (80) from the top of the tube (90) to the bottom. Element 70 is a set of openings (slots or channels) on the sidewall of the cylindrical tube which set is used to be fitted over the sides of a box at the corner.

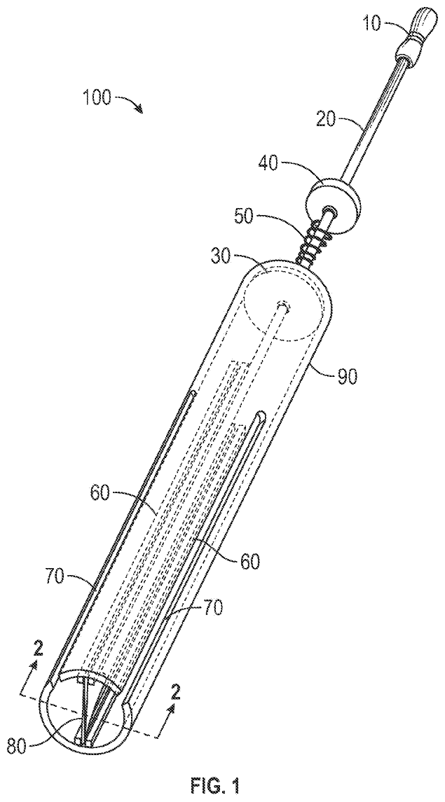

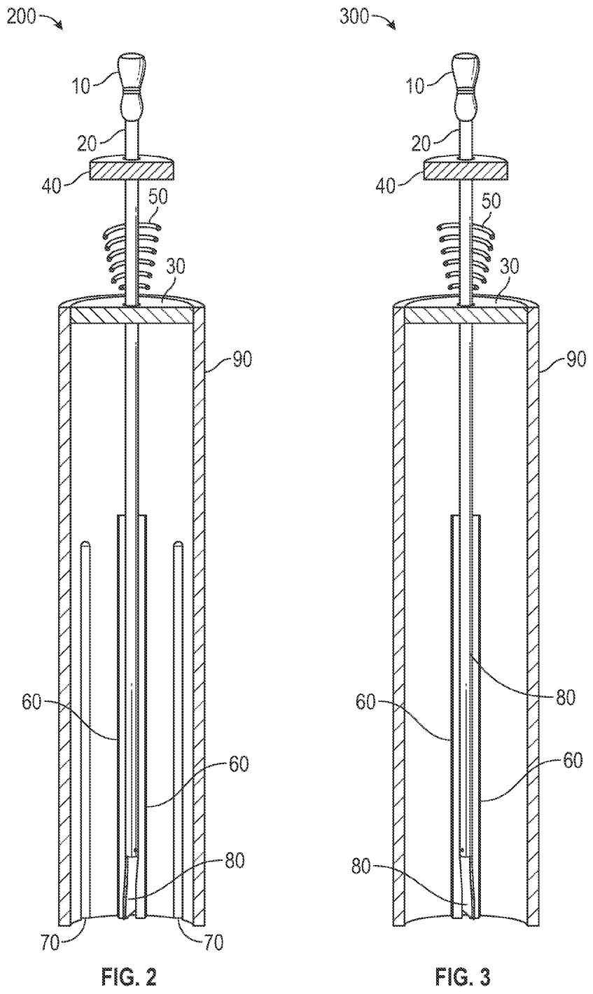

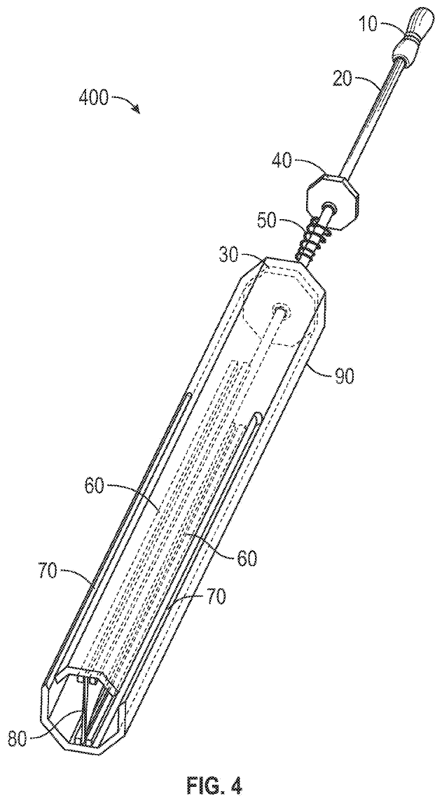

### DETAILED DESCRIPTION

Methods, systems, and apparatuses for cutting cardboard and corrugated paper are herein described. The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

As shown in the figures, the device of the present invention is a hand held and hand operated cutting blade connectively attached to the bottom end of a pole that is housed in and partially contained within a capped cylindrical tube wherein there are tracks installed to guide the cutting blade up and down within the tube. There are two openings (slots or channels) on the sidewall of the cylindrical tube which are used to be fitted over the sides of a box at the comer. As the tube is lowered to the bottom of the box the blade will slide up into the tube and come to a rest positioned at the top of the corner of the box. The pole with blade can then be easily pushed down through the corner of the box cutting it from top to bottom.

The device of the present invention is made by installing in a cylindrical tube (90), two sets of tracks or channels (60) on opposite interior sidewalls of said cylindrical tube (90). Two openings or slots are cut into the sidewalls of said cylindrical tube from the bottom of the tube in parallel alignment with the tube (90) to a length that is equal to the length of the cylindrical tube less the depth or thickness of the cap (30) plus a millimeter. Note the cap (30) will have a hole through the center for the pole (20) to pass, and is later installed on the top of the cylindrical tube.

The placement of the open channels is usually determined by forming a right triangle with its corners at the center point of the cylindrical tube and at two points along the outer edge of the tube sidewall so as maximally allow the tube to slide down the sides of a box smoothly wherein the outer edge of the corner of said box is positioned so as it passes through the center point axis of the cylindrical tube and the sides of the box pass through the open channels. The placement of the channels may be altered as desired.

The width of each of the two openings that are cut into or removed from the cylindrical tube is determined by the multiplying two and one half by the thickness of the cardboard and corrugated paper material the box to be cut is manufactured from. This enables the box corner being cut to pass smoothly through the open channels of the cylindrical tube from the bottom of the tube all the way up the side of the tube until nearly the top, just short of the cap (30). The width of the openings may be altered as desired.

A tube cap (30) with a hole through the center that is just slightly larger than the diameter of said pole (20) is placed onto said pole (20) as shown in the figures wherein said cap (30) is connectively attached to the top of said tube (90). In other words a tube cap (30) is slid onto said pole (20) such that the pole can pass freely through said cap (30). A handgrip (10) is connectively attached to the top end of said pole (20) and a cutting blade (80) is connectively attached to the bottom of said pole.

The pole (20), handgrip (10), and cutting blade (80) combination with cap (30) thereon is inserted into the top of said tube (90) and the cap (30) is secured in place connectively attaching said cap (30) to the top of said tube (90). The device can be used in this embodiment.

The device of the present invention may be further enhanced with the addition of a range limiting upper collar (40) attached onto and/or around said pole (20) at a distance equal to the height (length) of said tube (90) less the thickness or depth of said cap (30) plus a millimeter of added length to prevent the sides of a box from hitting said cap (30) when the device is used. The upper collar (40) is so positioned so as to prevent the pole (20), handgrip (10), and cutting blade (80) combination from extending out past the end of said tube (90).

The device of the present invention may be further enhanced with the addition of a recoil spring (50) or other suitable alternative motion arresting device such as, but not limited to, a pneumatic rod or cylinder system, and internal spring or pneumatic system installed within or on the outside of said pole. The recoil spring (50) or other suitable alternative provides enhanced safety by arresting (slowing) the downward motion of the pole (20), handgrip (10), and cutting blade (80) combination so as to prevent injury when the blade is forced downward through the cardboard and corrugated paper corner of a box by arresting (slowing) the downward motion of the pole (20), handgrip (10), and cutting blade (80) combination as it nears the end of said tube (90).

It is noted that the collar (40) and the spring (50) may be positioned either outside the tube (90) or inside it. In either configuration the function enhancement of these additions to the device is realized.

The device of the present invention may be further enhanced by the addition of rounding of the edges and/or corners at the bottom of said tube both at the inside edges and outside edges. The rounding of the edges and/or corners of the bottom provides enhanced utility in that it prevents the device of the present invention from catching or otherwise poking into or through the material of the box that is being cut thereby improving ease of use and smoothness of function.

The device of the present invention may be further enhanced by the addition of a cover, or cover with an integrated handhold, that would be positioned on top of the cap (30) over either or both the collar (40) and the spring (50), where these elements are included on the outside of the tube (90), or simply as an enhancement to the device. The addition of this option further enhances the device of the present invention by enabling the user to hold and manipulate the device using two (both) hands at the same time; one on the grip (10) and the other on the added cover, or cover with an integrated handhold positioned over and connectively attached to the device.

The device of the present invention may be further enhanced by the use of a lubricated guide pole or rail system as an alternative for the guide tracks (60) as shown in the presented embodiment in the figures. The guide tracks (60) as presented in the embodiment shown in the figures could readily be exchanged for a guide pole, rail, or other channel guiding type system to guide the outside edge of the cutting blade (80) instead of using the guide tracks (60) as shown. Additionally a guide channel or rail could be cut into or added onto the pole (20) as another alternative method to guide the cutting blade (80). The addition of this option may enhance the useable duty or life cycle of the device, and/or the smoothness of operation of the device.

The device of the present invention may be further enhanced by the use of a power assisted downward and/or upward pole (20) cutting blade (80) stroke that can be an automated or manual system. The addition of this option may enhance the useable duty or life cycle of the device, speed of operation, and/or the smoothness of operation of the device.

The device is used by placing the open channels (70) over two sides of a corner of a box and pressing the tube (90) down to the bottom of the box which slides the cutting blade (80) to the top of the corner of the box. Once the tube (90) is in position at rest at the bottom of the corner of a box, the grip (10) is held and used to push the pole (20) and attached cutting blade (80) through the cardboard and corrugated paper thereby cutting (cleaving) the sides of the box in a straight line following the tracks (60) inside the tube (90) from top to bottom in a single downward thrust motion—or multiple downward thrusting motions as needed depending upon the thickness of the cardboard and corrugated paper material.

It can be immediately appreciated by a person having ordinary skill in this art that the device of the present invention can be built from a wide range or variety of materials, and that the cylindrical shape of the tube may be any other fully enclosed shape and is not limited to the circular and octagonal embodiments shown in the figures. The cutting blade can be of any cutting edge type or cutting technology type. The materials to be selected for any given embodiment of the device of the present invention can be tailored to lighter duty or heavier duty uses as needed. The size, scale, and dimensions of the device of the present invention can be determined to be any size needed as determined by the length of the cutting required or the height or length of the sides of the boxes to be cut open at the corners.

1. (canceled)

2. (canceled)

3. (canceled)

4. I claim a box corner cutting device comprised of a cylindrical tube wherein two separate channels are cut through a sidewall of said cylindrical tube and said cylindrical tube has a cap that has a hole through its center for a pole with a handgrip connectively attached to the top end of said pole, a cutting blade connectively attached to the bottom end of said pole which then may travel up and down inside said tube wherein said cutting blade is maintained in alignment with and guided by channels connectively attached to the inside sidewall of said cylindrical tube, a collar connectively attached to said pole at a distance away from the bottom of said cutting blade that is approximately equal to the height of said tube which then prevents said cutting blade at the bottom end of said pole from exiting the bottom end of said cylindrical tube when said pole is advanced downwardly through said cylindrical tube, and a dampener connectively attached to said cap to slow and arrest the downward motion of said cutting blade as it gets close to the bottom open end of said tube when said pole is advanced downwardly through said cylindrical tube.

5. I claim the box corner cutting device according to claim 4 comprising a collar connectively attached to said pole at a distance away from the bottom of said cutting blade that is equal to the height of said tube which then prevents said cutting blade at the bottom end of said pole from exiting the bottom end of said cylindrical tube when said pole is advanced downwardly through said cylindrical tube, and a cover device to conceal said collar.

6. I claim the box corner cutting device according to claim 4 comprising a spring connectively attached to said cap to slow and arrest the downward motion of said cutting blade as it gets close to the bottom open end of said tube when said pole is advanced downwardly through said cylindrical tube, and a cover device to conceal said collar and said spring.

7. I claim the box corner cutting device according to claim 4 comprising a cover device to conceal said collar and said dampener.

8. I claim the box cutting device according to claim 4 wherein the dampener is a pneumatic dampener.
